(19) United States
(12) Patent Application Publication
(10) Pub. No.: US 2011/0149379 A1
(43) Pub. Date: Jun. 23, 2011

(54) MANUFACTURING METHOD OF ELECTRONIC PAPER DISPLAY DEVICE AND ELECTRONIC PAPER DISPLAY DEVICE USING THE SAME

(75) Inventors: Sang Moon Lee, Seoul (KR); Hwan-Soo Lee, Seoul (KR); Young Woo Lee, Gyunggi-do (KR); Sang Jin Kim, Suwon (KR); Jeong Bok Kwak, Suwon (KR)

(73) Assignee: SAMSUNG ELECTRO-MECHANICS CO., LTD.

(21) Appl. No.: 12/843,347

(22) Filed: Jul. 26, 2010

(30) Foreign Application Priority Data
Dec. 22, 2009 (KR) 10-2009-0129306

(51) Int. Cl. G02F 1/167; H01J 9/24

(52) U.S. Cl. 359/296; 445/24

(57) ABSTRACT

There are provided a method of manufacturing an electronic paper display device and an electronic paper display device manufactured by the method, and the method of manufacturing an electronic display device includes: providing a substrate having a plurality of walls and a plurality of cells defined by the walls; disposing at least one kind of rotators in the cells; disposing a display-sided electrode on the substrate to cover the rotators; and disposing a back electrode, opposite to the display-sided electrode, on the substrate, in which the rotators are arranged in the cells by a jig having a cylindrical center body, retaining grooves that are formed around the center body and retain the rotator, protrusions that are formed between adjacent retaining grooves, and a guide that is formed around the protrusions and has inlets and an outlet for the rotators.

The rotators can be regularly arranged in the cells by a roll-to-roll imprint process using a jig, such that it is possible to provide a method of manufacturing an electronic paper display device having an improved screen contrast ratio, and an electronic paper display device.

### CROSS-REFERENCE TO RELATED APPLICATIONS

This application claims the priority of Korean Patent Application No. 10-2009-0129306 filed on Dec. 22, 2009, in the Korean Intellectual Property Office, the disclosure of which is incorporated herein by reference.

### BACKGROUND OF THE INVENTION

1. Field of the Invention

The present invention relates to a method of manufacturing an electronic paper display device and an electronic paper display device manufactured by using the method, and more particularly, to a method of manufacturing an electronic paper display device implementing stable and uniform images and having an improved screen contrast ratio and an electronic paper display device manufactured by the method.

2. Description of the Related Art

A shift in information exchange and sharing methods is currently in demand, corresponding to modern society's requirement for a new information delivery paradigm. To meet this demand, the development of technologies associated with flexible electronic paper has recently been accelerated and these are now entering the phase of commercial development.

Compared with existing flat panel display devices, an electronic paper display requires relatively low manufacturing costs, and is far superior in terms of energy efficiency, since it is operable even with a very low level of energy, since backlighting or continuous recharge is unnecessary. Furthermore, electronic paper enables a high definition display, provides a wide viewing angle, and is equipped with a memory function that retains the display of letters (characters) even when unpowered. The above-described advantages make electronic paper applicable in a wide variety of technical fields, such as electronic books having paper-like sheets and moving illustrations, self-updating newspapers, reusable paper displays for mobile phones, disposable TV screens, and electronic wallpaper. There is a massive potential market for such electronic paper.

A technical approach for the implementation of electronic paper may be roughly divided into four methods: a twist-ball method, an electrophoretic method, a quick response-liquid power display (QR-LPD) method, and a cholesteric liquid crystal display method. Here, the twist ball method involves rotating spherical particles, each having upper and lower hemispheres having opposite electrical charges and different colors, by using an electric field. As for the electrophoretic method, colored charged particles mixed with oil are trapped in micro-capsules or micro-cups, or charged particles are made to respond to the application of an electric field. The QR-LPD method uses liquid powder. The cholesteric liquid crystal display method uses the selective reflection of cholesteric liquid crystal molecules. Of these methods of realizing electronic paper, the twist ball method generally includes a plurality of twist balls, each of which is composed of a white hemisphere and a black hemisphere and which are arranged between two parallel translucent sheets (hereafter, referred to as an ‘elastomer matrix’) made of an elastomer.

The twist ball has optical and electrical isotropic properties. In other words, negative charges are created in the white semisphere and positive charges are created in the black semisphere, such that a permanent dipole is produced therefrom. Further, the twist ball is coated with liquid so as to be rotatable in an elastomer matrix. That is, electronic paper using the twist balls can display desired images by forming an electric field in the elastomer matrix to selectively rotate the twist balls.

In electronic paper using the twist balls it is important to uniformly arrange the twist balls in the elastomer matrix to achieve high image definition. However, electronic papers using common twist balls have a low screen contrast ratio due to non-uniformity of the twist balls caused in attaching the twist balls to the elastomer matrix. In addition, there is a problem in that the manufacturing process is complex because it is required to coat each twist ball with liquid for rotation.

### SUMMARY OF THE INVENTION

An aspect of the present invention provides a method of manufacturing an electronic paper display device implementing stable and uniform images and having an improved screen contrast ratio.

According to an aspect of the present invention, there is provided a method of manufacturing an electronic paper display device that includes: providing a substrate having a plurality of walls and a plurality of cells defined by the walls; disposing at least one kind of rotators in the cells; disposing a display-sided electrode on the substrate to cover the rotators; and disposing a back electrode, opposite to the display-sided electrode, on the substrate, in which the rotators are arranged in the cells by a jig having a cylindrical center body, retaining grooves that are formed around the center body and retain the rotator, protrusions that are formed between adjacent retaining grooves, and a guide that is formed around the protrusions and has inlets and an outlet for the rotators.

The retaining groove may have a plurality of separation sections divided by a plurality of separation walls.

The retaining groove parallel with the long axis of the center body may have the separation sections thereof arranged in a line and the retaining groove parallel with the short axis of the center body may have one separation section.

The retaining groove parallel with the long axis of the center body may have the separation sections thereof arranged in a line and the retaining groove parallel with the short axis of the center body may have at least two separation sections.

The at least two separation sections may accommodate at least two different kinds of rotators for each of the sections.

The rotators may be composed of three kinds of rotators bringing out any one color of red, green, and blue.

The disposing of rotators in the cells may include: injecting the rotators into the retaining grooves through the inlets; rotating the jig such that the rotators correspond to the cells; and arranging the rotators in the cells by discharging the rotators through the outlet.

The at least any one of the walls and separation walls may be formed by an imprint, laser patterning, photolithography, or an etching process.

According to another aspect of the present invention, there is provided an electronic paper display device that includes: a display-sided electrode made of a transparent material; a back electrode disposed opposite to the display-sided electrode; a substrate having a plurality of walls disposed between the display-sided electrode and the back electrode and dividing the space between the display-sided electrode and the back electrode, and a plurality of cells defined by the walls; and at least one kind of rotators disposed in the cells, in which the rotators are arranged in the cells by a jig having a cylindrical center body, retaining grooves that are formed around the center body and retain the rotator, protrusions that are formed between adjacent retaining grooves, and a guide that is formed around the protrusions and has inlets and an outlet for the rotators.

The retaining groove may have a plurality of separation sections divided by a plurality of separation walls.

The retaining groove parallel with the long axis of the center body may have the separation sections thereof arranged in a line and the retaining groove parallel with the short axis of the center body may have one separation section.

The retaining groove parallel with the long axis of the center body may have the separation sections thereof arranged in a line and the retaining groove parallel with the short axis of the center body may have at least two separation sections.

The at least two separation sections may accommodate at least two different kinds of rotators for each of the sections.

The rotators may be composed of three kinds of rotators bringing out any one color of red, green, and blue.

The rotator may include a first display region stained any one of white and black and a second display region stained anyone of red, green, and blue, and the first and second display regions may have different charged properties.

At least any one of the walls and separation walls may be formed by an imprint, laser patterning, photolithography, or an etching process.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is an exploded perspective view schematically showing electronic paper manufactured by an electronic paper display device according to an embodiment of the present invention;

FIG. 1B is a plan view schematically showing a pixel region of FIG. 1A; and

FIGS. 2 through 5 are cross-sectional views illustrating each process in the method of manufacturing an electronic paper display device according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of elements may be exaggerated for clarity. Like reference numerals in the drawings denote like elements.

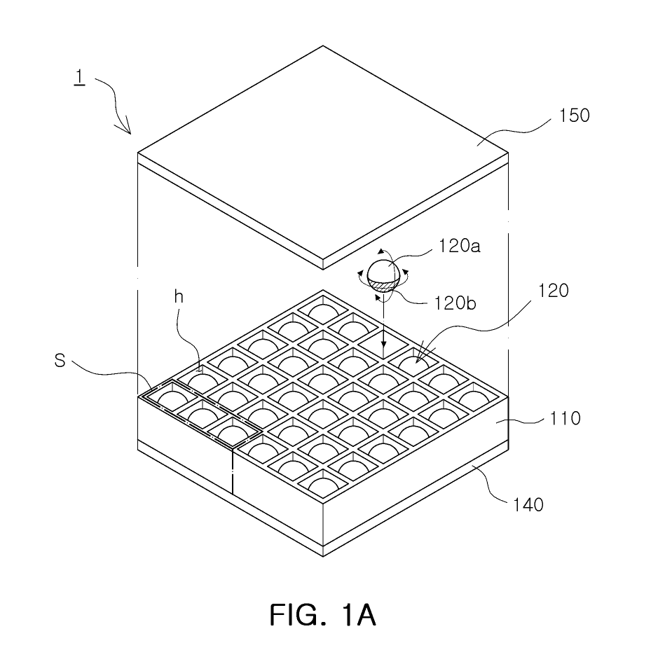

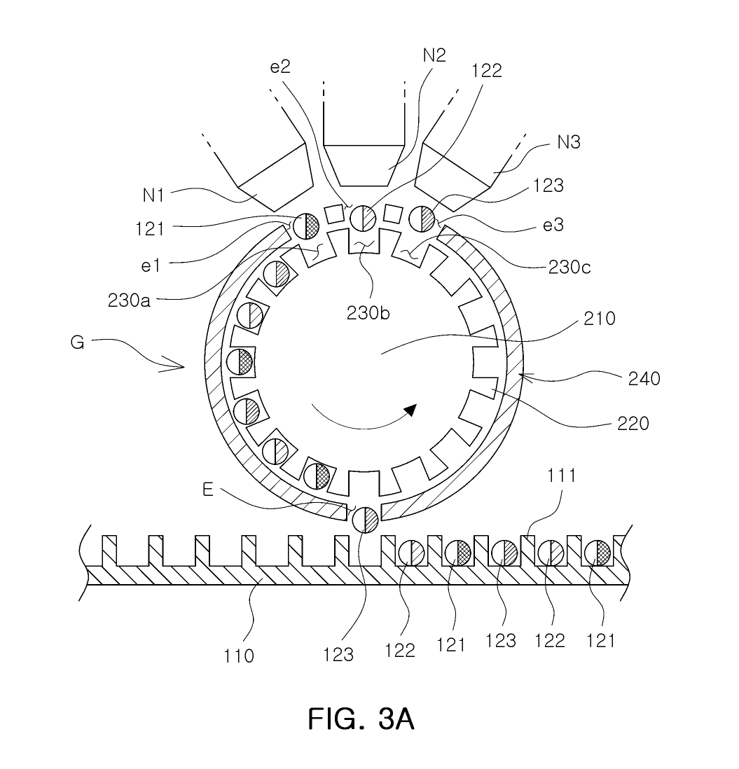

A method of manufacturing an electronic paper display device according to an embodiment of the present invention and an electronic paper display device manufactured by the method will be described hereafter with reference to FIGS. 1 and 3.

FIG. 1A is an exploded perspective view schematically showing electronic paper manufactured by a method of manufacturing an electronic paper display device according to an embodiment of the present invention, FIG. 1B is a plan view schematically showing a pixel region of FIG. 1A, FIG. 3A is a cross-sectional view illustrating a process of arranging rotators in cell with a jig and FIG. 3B is a plan view enlarging retaining grooves of FIG. 3A, in a method of manufacturing an electronic paper display device, using a roll-to-roll process, according to an embodiment of the present invention.

Referring to FIGS. 1A and 1B, an electronic paper display device 1 according to this embodiment includes a display-sided electrode 150 made of a transparent material and disposed on the display side, a back electrode 140 disposed opposite to the display-sided electrode 150, and a substrate 110 disposed between the display-sided electrode 150 and the back electrode 140.

The display-sided electrode 150 and the back electrode 140 can be made of electrode materials commonly used in the art of the present invention. For example, a conductive polymer, such as polythiophene and polyaniline, a metal, such as silver or nickel, a polymer film containing the metal, and ITO (Indium-Tin-Oxide) can be used.

Further, the back electrode 140 may be an electric field-applying element or a matrix address electrode which allows the rotators 120 to independently rotate. Further, the back electrode 140 may have a driving element allowing the rotators 120 in each cell h to be independently driven.

The substrate 110 may be made of flexible resin, for example, the substrate 110 may be made of PET (Polyethylene Terephthalate), PC (Polycarbonate), PMMA (Polymethyl Methacrylate), PEN (Polyethylene Naphthalate), PES (Polyether Sulfone), COC (Cyclic Olefin Copolymer), PDMS (Polydimethylsiloxane), or PUA (Poly Urethane Acrylate), or a mixture of one or more of them, but is not limited thereto.

The substrate 110 includes a plurality of walls 111 disposed between the display-sided electrode 150 and the back electrode 140 and dividing the space between the display-sided electrode 150 and the back electrode 140 and a plurality of cells h defined by the walls 111. In this configuration, the cells h according to an embodiment of the present invention accommodate the rotators (120: 121, 122, 123), respectively. Further, the cells h may be filled with dielectric liquid to allow the rotators 120 to rotate with ease. In addition, a pixel region S is defined by a plurality of adjacent cells h accommodating a plurality of rotators 120 having different colors.

Different colors are stained to the rotators 120 and the rotators have two display regions 120a and 120b having different charged properties, respectively.

In the two display regions, any one of white and black is stained to the first display region 120a and any one of red, green, and blue colors is stained to the second display region 120b. Further, when the first display region 120 has positive charges, the second display region 120b has negative charges.

When voltage is applied by the display-sided electrode 150 and the back electrode 140 to the rotators 120, the rotators 120 rotate in accordance with the magnitude and direction of the voltage and bring out their colors in the two first and the second display regions 120a and 120b.

Rotators 120 of the same kind implies that the colors stained the second display region 120 are the same, that is, the same color in red, green, and blue, except for white (or black), is applied.

Although an example including the first to third rotators 121, 122, and 123 is described in this embodiment, the type of rotators 120 is not limited thereto.

For example, the first rotator 121 may bring out red, the second rotator 122 may bring out green, and the third rotator may bring out blue.

The first to third rotators 121, 122, and 123 are disposed in adjacent cells h, and the arrangement is not specifically limited, if it is regular. A regular arrangement implies that the rotators 120 of the same kind are arranged to correspond to each other, even if they are disposed in different pixel regions S.

The first to third rotators 121, 122, and 123 can be regularly arranged, as described above, by a jig G shown in FIG. 3A. The jig G has a cylindrical center body 210, retaining grooves 230 that are formed around the center body 210 and retain the rotators 120, protrusions 220 that are formed between adjacent retaining grooves 230, and a guide 240 that is formed around the protrusions 220 and has inlets e1, e2, and e3 and an outlet E for the rotators 120.

Further, as shown in FIG. 3B, each of the retaining grooves (230: 230a, 230b, 230c) has a plurality of separation sections 233a, 233b, and 233c divided by a plurality of separation walls 231a, 231b, and 231c. Further, in the retaining grooves 230, the separation sections 233a, 233b, and 233c are arranged in a line in parallel with the direction of the long axis of the center body 210, and one separation section 233a, 233b, and 233c is arranged in parallel with the short axis of the center body 210.

That is, in the electronic paper display device 1 according to the present invention, it is possible to regularly arrange the rotators 120 in the cells h defined by the walls 111 formed by a roll-to-roll process using the jig G. Therefore, the rotators 120 disposed in the cells h can be uniformly arranged at a regular distance, thereby improving the screen contrast ratio.

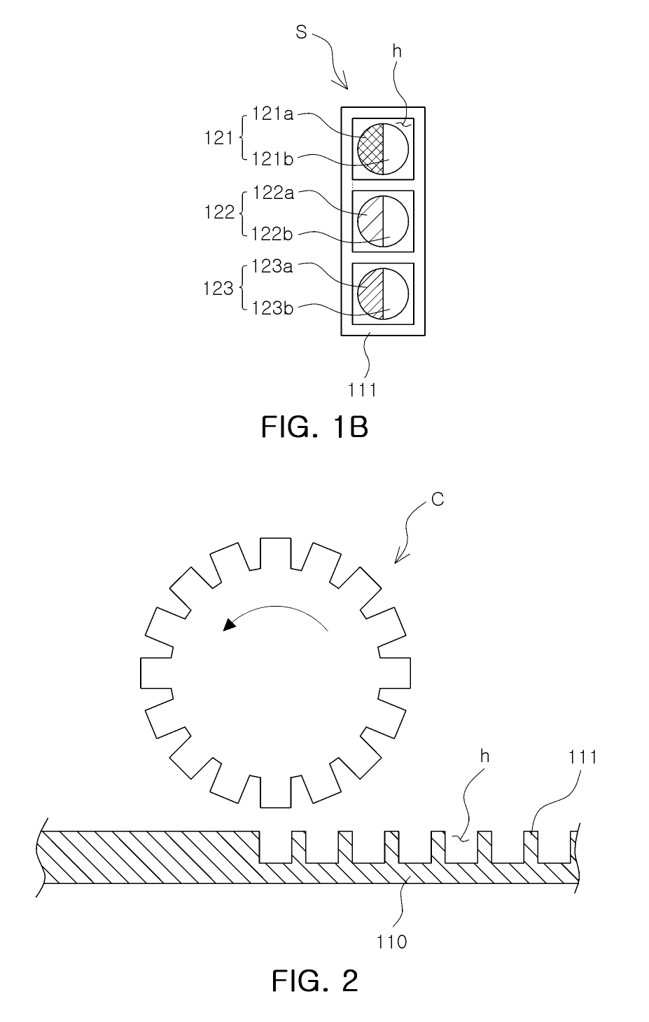

A method of manufacturing an electronic paper display device according to an embodiment of the present invention is described hereafter with reference to FIGS. 2 through 5.

FIGS. 2 through 5 are cross-sectional views illustrating each process in the method of manufacturing an electronic paper display device according to an embodiment of the present invention. This embodiment is limited to a case in which the substrate, the back electrode, and the display-sided electrode are made of flexible materials so as to use the roll-to-roll process.

A method of forming the walls 111 on the substrate 110, using a roll-to-roll imprint process, is first described.

FIG. 2 is a cross-sectional view illustrating a process of forming walls on a substrate, in a method of manufacturing an electronic paper display device, using the roll-to-roll process, according to an embodiment of the present invention.

As shown in FIG. 2, the walls are formed by pressing the substrate 110 with a roll stamp C with an embossed pattern corresponding to cells h to be formed on the substrate 110. Therefore, a pattern corresponding to the embossed pattern of the roll stamp Cis formed on the substrate 110. In other words, the portions of the substrate 110, which correspond to the protrusions of the roll stamp C, are pressed and the portion of the substrate 110, which correspond to the depressed portions of the roll stamp C, become the walls 111, such that the cells h defined by the walls 111 are formed.

The width of the cell h may be slightly larger than the diameter of the first rotator 121 and the height of the wall 111 may be slightly larger than the diameter of the first rotator 121, but the height of the wall 111 is not limited thereto.

A Self-Assembled Monolayer (SAM) coating may be performed to the roll stamp C. With the roll stamp C SAM-coated, when the roll stamp C presses the substrate 110, the roll stamp C can be easily separated from the substrate 110. Further, the material of the substrate 110 is not specifically limited as long as it is flexible, as described above, such as a thermosetting resin or UV curable resin.

Meanwhile, when thermosetting epoxy is used for the substrate 110, the imprint process can be dualized to more efficiently form the walls 111. In other words, a method of heat-pressing the roll stamp C to the substrate for 30 minutes within a temperature range (e.g. about 100° C.) in which the viscosity of the substrate 110 is the lowest, increasing the temperature is increased to a range of temperature (e.g. about 180° C.) where the substrate 110 can be hardened, to harden the substrate 110 with the pressing maintained, and then separating the roll stamp C from the substrate 110. Using this method makes it possible to efficiently transcribe the pattern of the roll stamp C to the substrate 110 and efficiently maintain the shape of the pattern transcribed to the substrate 110, that is, the walls 111, in or after separation. As described above, since the wall 111 is formed by the imprint process using the roll stamp C, it is possible to variously adjust the shape and size of the cells h. In other words, the shape and size of the cells h become different by variously forming the pattern of the roll stamp C.

A method of arranging the rotators 120 in the cells h formed on the substrate 110 is next described.

FIG. 3A is a cross-sectional view illustrating a process of arranging rotators in cell with a jig and FIG. 3B is a plan view enlarging the retaining grooves of FIG. 3A, in a method of manufacturing an electronic paper display device, using a roll-to-roll process, according to an embodiment of the present invention.

As shown in FIG. 3A a plurality of rotators 120 can be disposed in desired cells h by a jig G.

In this configuration, the jig G has a cylindrical center body 210, retaining grooves 230 that are formed around the center body 210 and retain the rotators 120, protrusions 220 that are formed between adjacent retaining grooves 230, and a guide 240 that is formed around the protrusions 220 and has inlets e1, e2, and e3 and an outlet E for the rotators 120.

In this configuration, as shown in FIG. 3B, each of the retaining grooves (230: 230a, 230b, 230c) has a plurality of separation sections 233a, 233b, and 233c divided by a plurality of separation walls 231a, 231b, and 231c. Further, in the retaining grooves 230, the separation sections 233a, 233b, and 233c are arranged in a line in parallel with the direction of the long axis of the center body 210, and one separation section 233a, 233b, and 233c is arranged in parallel with the short axis of the center body 210.

First, the first to third rotators 121, 122, and 123 are injected to the retaining grooves 230a, 230b, 230c through the inlets e1, e2, and e3 of nozzles N1, N2, and N3. Next, the jig G is rotated such that the first to third rotators 121, 122, and 123 are located above desired cells h. After the first to third rotators 121, 122, and 123 are located above the desired cells h, the jig G is stopped the first to third rotators 121, 122, and 123 are discharged through the outlet E of the guide 240 to be arranged in the cells h at the desired location.

It is also possible to regularly arrange the first to third rotators 121, 122, and 12c to desired locations, in accordance with the user's design of the electronic paper display device 1.

Next, a method of injecting a liquid-state dielectric 130 onto the substrate with the first to third rotators 121, 122, and 123 arranged in the cells h.

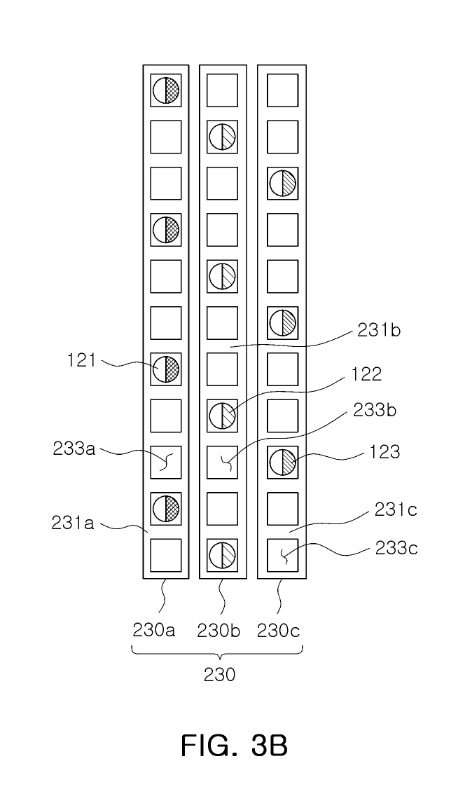

FIG. 4 is a cross-sectional view illustrating a process of injecting the liquid-state dielectric into the cells with the first to third rotators arranged therein, in a manufacturing method of an electric paper display device using the roll-to-roll process according to an embodiment of the present invention.

As shown in FIG. 4, the liquid-state dielectric 130 is applied through the nozzle N to the substrate 110 having the first to third rotators 121, 122, and 123 arranged. The applied liquid-state dielectric 130 is pushed by a squeeze D to fill the inside of the cells h, that is, the spaces between the walls 111 and the first to third rotators 121, 122, and 123.

A method of attaching the back electrode 140 and the display-sided electrode 150 onto the substrate 110 is next described.

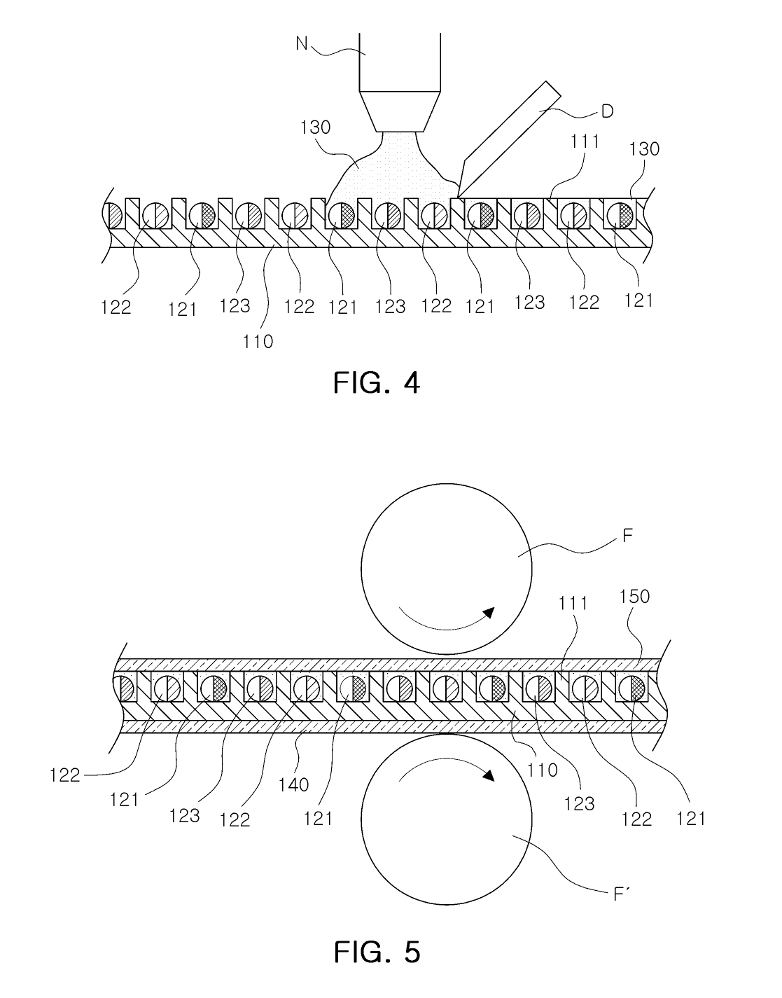

FIG. 5 is a cross-sectional view illustrating a process of attaching the back electrode and the display electrode to the substrate with the rotators and the liquid-state dielectric thereon, using the roll-to-roll process, in a method of manufacturing an electronic paper display device using the roll-to-roll process according to the present invention.

As shown in FIG. 5, the back electrode 140 and the display-sided electrode 150 are disposed on the substrate 110 and then the display-sided electrode 150 is attached to the upper surfaces of the walls 111 of the substrate and the back electrode 140 is attached to the lower surface of the substrate 110 by the roll-to-roll process. In detail, upper and lower rollers F and F′ rotate, and the back electrode 140, the substrate 110, and the display-sided electrode 150 are pressed while moving between the upper and lower rollers F and F′, such that the back electrode 140 and the display-sided electrode 150 are attached. That is, the display-sided electrode 150 is attached to the upper surfaces of the walls 111 of the substrate and the back electrode 140 is attached to the lower surface of the substrate 110, by the pressure of the upper and lower rollers F and F′. In this configuration, the back electrode 140 and the display-sided electrode 150 have a bonding layer to be attached to the walls 111 and the lower surface of the substrate 110. The bonding layer is a thin bonding layer (not shown) made of a UV curable resin and made to have a thickness of around 10 μm or around 5 μm. As described above, the back electrode 140 and the display-sided electrode 150 are attached to the substrate 110 by forming a thin bonding layer on the back electrode 140 and the display-sided electrode 150, disposing the thin bonding layer of the display-sided electrode 150 on the upper surface of the walls and the bonding layer of the back electrode 140 on the lower surface of the substrate 110, pressing them with the upper and lower rollers F and F′, and then radiating UV light thereupon.

Therefore, the processes illustrated in FIGS. 2 through 5 are continuously performed in the roll-to-roll process. The walls and separation walls may be formed by a common imprint, laser patterning, photolithography, or an etching process, other than the imprint process using the roll-to-roll process.

According to the embodiments of the present invention, since the rotators can be arranged in the cells by the imprint process using the jig, it is possible to provide a method of manufacturing an electronic paper display device having an improved screen contrast ratio and an electronic paper display device manufactured by the method.

Further, it is possible to simply the entire manufacturing process by replacing the process of coating the rotators with liquid by the process of injecting liquid into the cells or the pixel regions.

Further, the method of manufacturing an electronic paper display device according to the present invention makes it possible to reduce the manufacturing cost and implement mass production by collectively simplifying the process of forming the walls, injecting the rotators and the liquid, and pressing the substrate, using the roll-to-roll process.

Although rotators having red, green, and blue were described throughout the embodiments of the present invention, the present invention is not limited thereto, and for example, this configuration may also be applied to the rotators having black or white color by forming one retaining groove or a plurality of retaining grooves.

As set forth above, according to exemplary embodiments of the invention, the rotators can be regularly arranged in the cells by a roll-to-roll imprint process using a jig, such that it is possible to provide a method of manufacturing an electronic paper display device having an improved screen contrast ratio, and an electronic paper display device.

Further, it is possible to simplify the entire manufacturing process by replacing a process of coating the rotators with liquid by a process of injecting liquid into the cells or the pixel region.

Further, the method of manufacturing an electronic paper display device according to the present invention makes it possible to reduce the manufacturing cost and implement mass production by collectively simplifying the process of forming the walls, disposing the rotators, injecting the liquid, and pressing the substrate, using the roll-to-roll process.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing an electronic paper display device, comprising:
providing a substrate having a plurality of walls and a plurality of cells defined by the walls;
disposing at least one kind of rotators in the cells;
disposing a display-sided electrode on the substrate to cover the rotators; and
disposing a back electrode, opposite to the display-sided electrode, on the substrate;
wherein the rotators are arranged in the cells by a jig having a cylindrical center body, retaining grooves that are formed around the center body and retain the rotator, protrusions that are formed between adjacent retaining grooves, and a guide that is formed around the protrusions and has inlets and an outlet for the rotators.

2. The method of manufacturing an electronic paper display device of claim 1, wherein the retaining groove has a plurality of separation sections divided by a plurality of separation walls.

3. The method of manufacturing an electronic paper display device of claim 2, wherein the retaining groove parallel with the long axis of the center body has the separation sections thereof arranged in a line and the retaining groove parallel with the short axis of the center body has one separation section.

4. The method of manufacturing an electronic paper display device of claim 2, wherein the retaining groove parallel with the long axis of the center body has the separation sections thereof arranged in a line and the retaining groove parallel with the short axis of the center body has at least two separation sections.

5. The method of manufacturing an electronic paper display device of claim 4, wherein the at least two separation sections accommodate at least two different kinds of rotators for each of the separation sections.

6. The method of manufacturing an electronic paper display device of claim 1, wherein the rotators are composed of three kinds of rotators bringing out any one color of red, green, and blue.

7. The method of manufacturing an electronic paper display device of claim 5, wherein the disposing of rotators in the cells includes:
injecting the rotators into the retaining grooves through the inlets;
rotating the jig such that the rotators correspond to the cells; and
arranging the rotators in the cells by discharging the rotators through the outlet.

8. The method of manufacturing an electronic paper display device of claim 2, wherein at least any one of the walls and separation walls are formed by an imprint, laser patterning, photolithography, or an etching process.

9. An electronic paper display device, comprising:
a display-sided electrode made of a transparent material;
a back electrode disposed opposite to the display-sided electrode;
a substrate having a plurality of walls disposed between the display-sided electrode and the back electrode and dividing the space between the display-sided electrode and the back electrode, and a plurality of cells defined by the walls; and
at least one kind of rotators disposed in the cells,
wherein the rotators are arranged in the cells by a jig having a cylindrical center body, retaining grooves that are formed around the center body and retain the rotator, protrusions that are formed between adjacent retaining grooves, and a guide that is formed around the protrusions and has inlets and an outlet for the rotators.

10. The electronic paper display device of claim 9, wherein the retaining groove has a plurality of separation sections divided by a plurality of separation walls.

11. The electronic paper display device of claim 10, wherein the retaining groove parallel with the long axis of the center body has the separation sections thereof arranged in a line and the retaining groove parallel with the short axis of the center body has one separation section.

12. The electronic paper display device of claim 10, wherein the retaining groove parallel with the long axis of the center body has the separation sections arranged in a line and the retaining groove parallel with the short axis of the center body has at least two separation sections.

13. The electronic paper display device of claim 12, wherein the at least two separation sections accommodate at least two different kinds of rotators for each of the sections.

14. The electronic paper display device of claim 9, wherein the rotators are composed of three kinds of rotators bringing out any one color of red, green, and blue.

15. The electronic paper display device of claim 9, wherein the rotator includes a first display region stained any one of white and black and a second display region stained any one of red, green, and blue, and
the first and second display regions have different charged properties.

16. The electronic paper display device of claim 10, wherein at least any one of the walls and separation walls are formed by an imprint, laser patterning, photolithography, or an etching process.
